(19) United States
(12) Patent Application Publication
(10) Pub. No.: US 2006/0145466 A1
(43) Pub. Date: Jul. 6, 2006

(54) Advertisement and Promotional Distribution System Through Dry Cleaning Establishments, Similar Processes and Hotels

(75) Inventor: Jose Javier Vazquez Coria, Pachuca (MX)

Correspondence Address: CHRISTOPHER J. KULISH, ESQ, HOLLAND & HART LLP, P. O. BOX 8749, DENVER, CO, 80201-8749, US

(73) Assignee: CORIA COMERCIAL, S.A. DE C.V., Pachuca (MX)

(21) Appl. No.: 10/905,155

(22) Filed: Dec. 17, 2004

(51) Int. Cl. B42D 15/00

(52) U.S. Cl. 283/56

(57) ABSTRACT

This invention is related to an alternative advertising a promotional system with unique features, which offer specific qualities to the advertisers, suppliers and final customers. The object of this invention is to provide a novel, efficient, economical and income producing system, totality different to the ones already existing in the market at the present time, with an operation system and a simple business model.

### BACKGROUND OF THE INVENTION

At the present time, massive advertisement arrives to most of the population, without being able to segment the target market of clients to who attack by advertisers, likewise this kind of means are ephemeral and very expensive such as the radio and television.

While the printed advertisements, massive or not, hardly pass through the home door and in most of the cases they do not arrive up to the privacy of the same, this joined together to the fact that some of them have cost for the customer.

With the purpose to offer tangibles benefits for the advertisers, advertisement supplier and final customers, the present system was development, since it is an efficient and economical system for the advertiser and it has tangible benefits to the advertisement supplier and final customer.

### DETAILED DESCRIPTION

The commercial model of this business, is centered in a franchise scheme, being said franchises responsible for the sale and marketing of advertising spaces which are inside a label, one embodiment of which is identified as the “CLEANPROMO” label or advertising poster, which will be detailed further. A master franchiser makes a selection process of those candidates or persons interested in acquiring the franchise.

Once the franchise is settled, a market analysis is made in order to determine the supplier universe of “CLEANPROMO” labels (dry cleaning establishments, hotels, and the like), as well as the potential advertiser universe with segmentation by line of business.

During the first franchise stage the franchisee is trained to carry out the negotiations and closings with suppliers (dry cleaning establishments, hotels, and the like) either in a local manner or with national and international corporations.

Once the corresponding agreements have been effected with the suppliers and having secured the whole advertisement placement, the commercialization stage of the advertisement space is initiated.

One embodiment of an instrument on which the advertisement spaces are commercialized is called a “CLEANPROMO” label, which is an offset color selection printing, sized, in a preferred embodiment, of 57×40 cm, printed only at the front and with special tab cut so as to hang it in a hanger for cloths, in addition to paper cuttings or pre-cuts to be able to detach coupons and promotions, preferably printed in bright art paper of 150 g.

The “CLEANPROMO” label may be divided up to 22 spaces to be commercialized of which sizes vary depending on the location in the same. Aspects of the “CLEANPROMO” label or advertising poster are also disclosed in U.S. patent application Ser. No. 10/905,154, entitled “Advertising Poster Inside or in the Delivering Packing of Garments Processed by Dry Cleaning Establishments, Laundries or Similar Treatment,” which is incorporated herein by reference in its entirety.

What the franchise promotes is that the franchisee is only responsible for the commercialization of the advertising spaces, while the design, printing, logistic and transportation are responsibility of the master franchiser.

In this way it is secured that the franchisee in each place, be only worried of the commercial ambit and not of the operation and logistic, which brings as consequence a dedicated and effective commercial net.

An operation manual for franchises has been developed, which determines the operation model for the commercialization, negotiation of suppliers, as well as design and printing technical details that the “CLEANPROMO” label has to have, maintaining thus quality standards in all of these ambits.

Support materials will be deliver to each franchiser, such as demonstrative system brochures and folders, so as to facilitate the commercialization, in addition to elements to formalize the operations such as printed forms called “Orders of Entry/Publication” where the advertisements and payments are secured, as well as the advertiser secures the prices continuity and spaces reservations.

The suppliers with whom the corresponding agreements are signed, are the vehicle to send the advertiser publicity to the customer through a “CLEANPROMO” label, which is inserted in each hook of the dry cleaning establishment order that are processed in the establishment of the suppliers joined together that the last ones receive an economical benefit for each “CLEANPROMO” label inserted.

The additional labor made by the suppliers is only to insert a “CLEANPROMO” label in the hook of the garment orders to process, so as to place later the plastic bag over the cloths. Therefore, the additional effort made by the supplier can be considered minimum compared with the tangible benefit obtained with the insertion of each “CLEANPROMO” label.

Hereby the customer directly acquire, without additional cost for him, a full range of benefits which include coupons, discounts, courtesies, publicity, etc. joined together to the fact that he does not have to acquire the publication, unlike of magazines or newspapers and having the additional advantage of having the security that it arrives up to privacy of home, and not only to that person who picks up the dry cleaning orders but they are seen by all the home members.

Notwithstanding the above mentioned, in this system the publicity distribution is constant and not sporadic, since usually the dry cleaning establishment services are used with certain periodicity and by certain economic sectors of the population, thereby joined together all the advantages before mentioned, the publicity is directed to a specific sector of the population.

The impact received by the customer with this kind of publicity is novel by virtue that a space is used, which previously at the present invention had not been exploited and all the related parties receive benefit, that is, franchiser, franchisee, supplier, advertiser and customer, thereby the system result almost perfect.

What is claimed is:

1. A system comprising a business mechanism as of the franchise granting, by a master franchiser who has the business operative charge; a franchisee who is given with counseling and material in order that he be able to contact both advertisers and suppliers, obtaining the last ones an economical benefit for each “CLEANPROMO” label placed on the dry cleaning orders.

2. The business mechanism is initiated from the granting of franchise agreements, which offer tangible benefits to all the implicated parties, since the advertiser is allowed to publish and/or promote its product or service in a constant way by coupons inserted in a “CLEANPROMO” label; without cost for the customer and systematically securing a frontal impact to the customers with a specific buying power; and with the possibility of being quantified due to the coupons exchange, having the option of advertising in a local, regional or national manner; and to arrive systematically up to the home privacy.

3. The supplier is allowed to give to his clients or final customers an added value without additional cost, this is due to the discounts and promotions given by advertisers; the design and printing quality joined together to the quality of the advertiser that gives prestige to the supplier.

4. The supplier receives an economical compensation for each “CLEANPROMO” label placed in the dry clean establishment order, thereby he obtains an alternative income only for adding a step in his regular business process.

5. The franchiser is allowed to have attractive profit margins with a simple and efficient operation model due to the master franchiser has resolved the logistic and operative problems, who is the one in charge of the “CLEANPROMO” label printing and sending of the same to the franchisee, in order to the last one deliver it later to the supplier who will be the vehicle to the customer.
